(19) United States
(12) Patent Application Publication
(10) Pub. No.: US 2004/0065126 A1
(43) Pub. Date: Apr. 8, 2004

(54) Locking device

(76) Inventor: Kuo-Tsung Yang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/401,847

(22) Filed: Mar. 31, 2003

(30) Foreign Application Priority Data
Oct. 2, 2002 (TW) 091215570

(51) Int. Cl. E05B 73/00

(52) U.S. Cl. 70/58

(57) ABSTRACT

A locking device includes a receiving portion adapted to connect to a secondary object and having a receiving space, a limiting portion securely connected to the receiving portion, a bolt movably received in the receiving portion; and a cable selectively extending through the limiting hole to limit movement of the bolt such that the connection of the receiving portion to the secondary object is secured.

### BACKGROUND OF THE INVENTION

1. Field of the Invention

The present invention relates to a locking device, and more particularly to a locking device for conveniently securing a portable object.

2. Description of Related Art

There are numerous kinds of locks with different additional functions. However, no matter how different they might be, the common function of these locks is to secure a valuable and important object e.g., a laptop computer. For travelers, businessmen, etc in order to keep in touch with the updated sources, a laptop computer seems to be a necessity in their routine daily life. When these people stop for a short break and start using the laptop computer to browse the information, how they are going to ensure the safety of the laptop computer becomes an issue in case they have to leave the laptop computer for someplace else for a while.

Furthermore, in a computer fair where hundreds and thousands of people flock into the exhibition site to view state of the art computer devices, the exhibitor may not be able to watch every visitor in the booth. Thus, it may be difficult to prevent unauthorized personnel from stealing the computer on display at the booth.

To overcome the shortcomings, the present invention tends to provide an improved locking device to mitigate and obviate the aforementioned problems.

### SUMMARY OF THE INVENTION

The primary objective of the present invention is to provide an improved locking device having a receiving portion and a limiting portion. The receiving portion is adapted to receive therein a secondary object from the laptop computer. A bolt extending through the receiving portion from the limiting portion is adapted to connect to the secondary object. A cable extending through the limiting portion is able to limit the movement of the bolt so that after the cable extends through the limiting portion, movement of the bolt extending into the receiving portion and adapted to connect to the secondary object is limited and the object secured to the secondary object is locked.

Another objective of the present invention is to provide an improved locking device having means for limiting movement of the bolt such that engagement between the bolt and the secondary object is secured.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of two locking devices in series via a cable;

FIG. 2 is a schematic side view showing that a secondary object is connected to the bolt;

FIG. 3 is a perspective view of a second preferred embodiment of the locking device of the present invention;

FIG. 4 is a schematic cross sectional view of the locking device in FIG. 3;

FIG. 5 is a schematic cross sectional view showing the movement of the actuating rod limits movement of the bolt;

FIG. 6 is a schematic view of the application of the locking device of the present invention in FIG. 3;

FIG. 7 is a perspective view of a third preferred embodiment of the locking device of the present invention; and

FIG. 8 is a schematic view showing the application of the locking device in FIG. 7.

### DETAILED DESCRIPTION OF THE PREFERRED EMBODIMENT

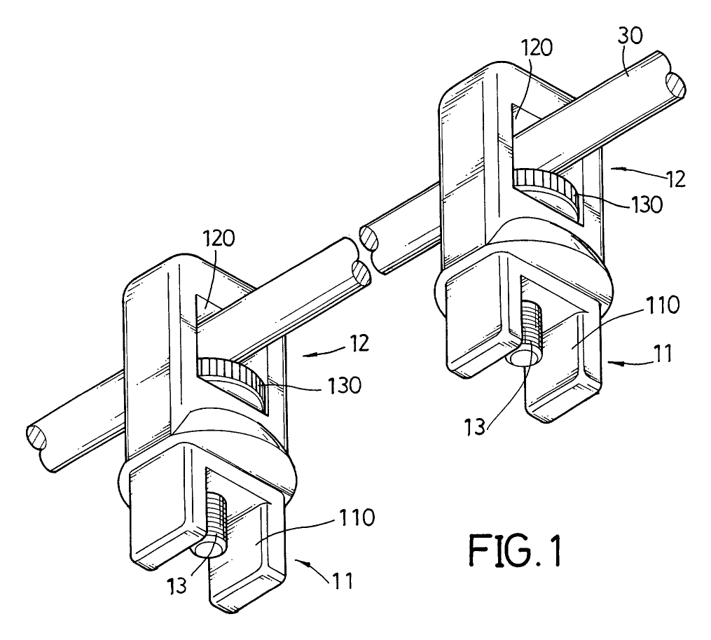

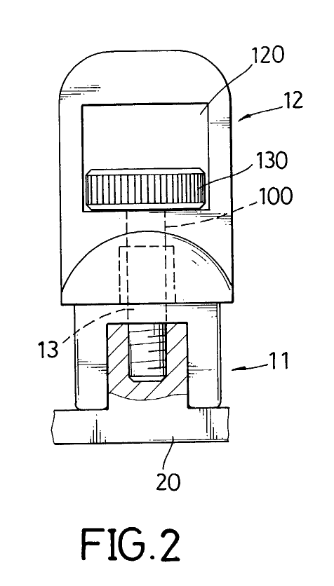

With reference to FIGS. 1 and 2, the locking device in accordance with the present invention includes a receiving portion (11) and a limiting portion (12).

The receiving portion (11) defines therein a receiving space (110) for connection with a secondary object (20), such as a nut on a rear side of a laptop computer for connection with a terminal.

The limiting portion (12) is securely connected to the receiving portion (11) and has a limiting hole (120) defined in the limiting portion (12) to communicate with the receiving space (110) via a through hole (100) which is defined through a joint between the receiving portion (11) and the limiting portion (12).

A bolt (13) with a knob (130) formed on a distal end of the bolt (13) and received in the limiting hole (120) extends through the through hole (100) to the receiving portion (1).

A cable (30) extending through the limiting hole (120) is able to limit movement of the bolt (13) after the bolt (13) is connected to the secondary object (20).

When the locking device is in use and suppose the secondary object is the nut on the rear side of the laptop computer, secured engagement between the bolt (13) and the secondary object (20) by turning the knob (130) secures the receiving portion (11) with the object to be locked. Then the operator is able to use the cable (30) to extend through the limiting hole (120) and wind around a fixing element such as a table leg to protect the object from being stolen.

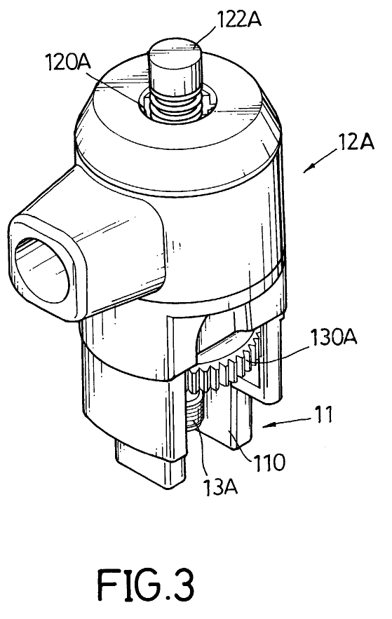

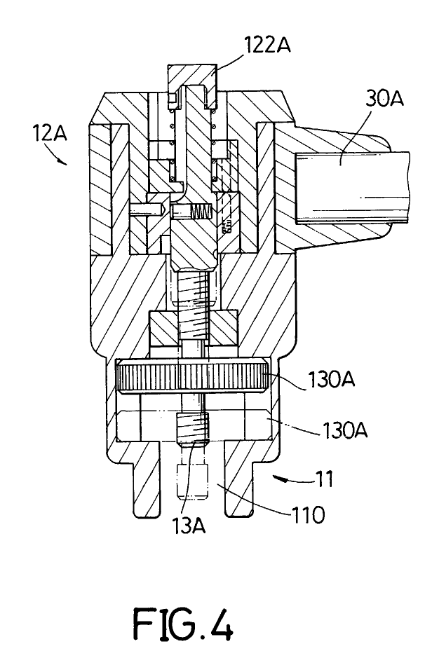

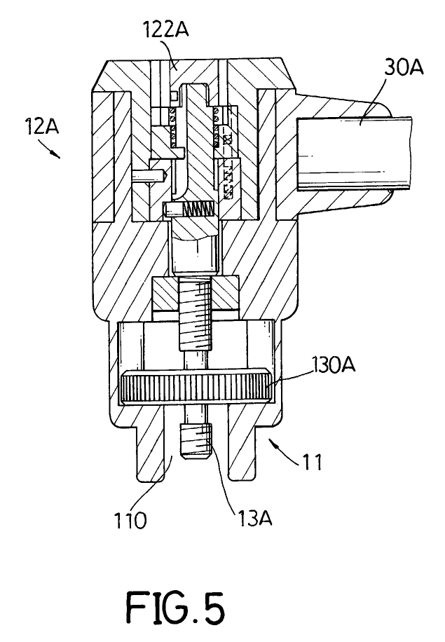

With reference to FIGS. 3, 4 and 5, the second preferred embodiment of the present invention is shown. The locking device of the present invention has a receiving portion (11) and a limiting portion (12A).

The receiving portion (11) defines therein a receiving space (110) for connection with a secondary object (20) (as shown in FIG. 2), such as a nut on a rear side of a laptop computer for connection with a terminal.

The limiting portion (12A) is securely connected to the receiving portion (11) and has a limiting hole (120A) defined in the limiting portion (12A) to communicate with the receiving space (110).

A bolt (13A) with a knob (130A) formed on a distal end of the bolt (13A) extends between the limiting hole (120A) and the receiving space (110).

A cable (30A) is securely connected to a side of the limiting portion (12A). An actuating rod (122A) movably received in the limiting portion (12A) and a distal end thereof engages with a distal end of the bolt (13). The actuating rod (122A) is able to move from a first position to a second position and vice versa. When the actuating rod (122A) is at the second position, the limiting portion (12) is locked and only a proper key (not shown) is able to unlock the limiting portion (12). When the actuating rod (122A) is at the first position, the limiting portion (12A) is unlocked and thus the bolt (13A) is able to move to allow the bolt (13A) to detach engagement with the secondary object (20) (the nut as shown in the first embodiment).

That is, when the embodiment of this type is in use, forcing the actuating rod (122A) to move from the first position- to the second position locks the limiting portion (12A). Furthermore, because the distal end of the actuating rod (122A) engages with the distal end of the bolt (13A), the movement of the actuating rod (122A) from the first position to the second position limits the movement of the bolt (13A).

When the movement of the bolt (13A) is limited, even if there is an unauthorized person trying to unscrew the engagement between the nut of the laptop computer and the bolt (13A), due to the abutment of the actuating rod (122A) to the distal end of the bolt (13A) and locked status of the limiting portion (12A), the unauthorized person can not unscrew the engagement between the bolt (13A) and the nut. Thereby the safety of the laptop computer is protected.

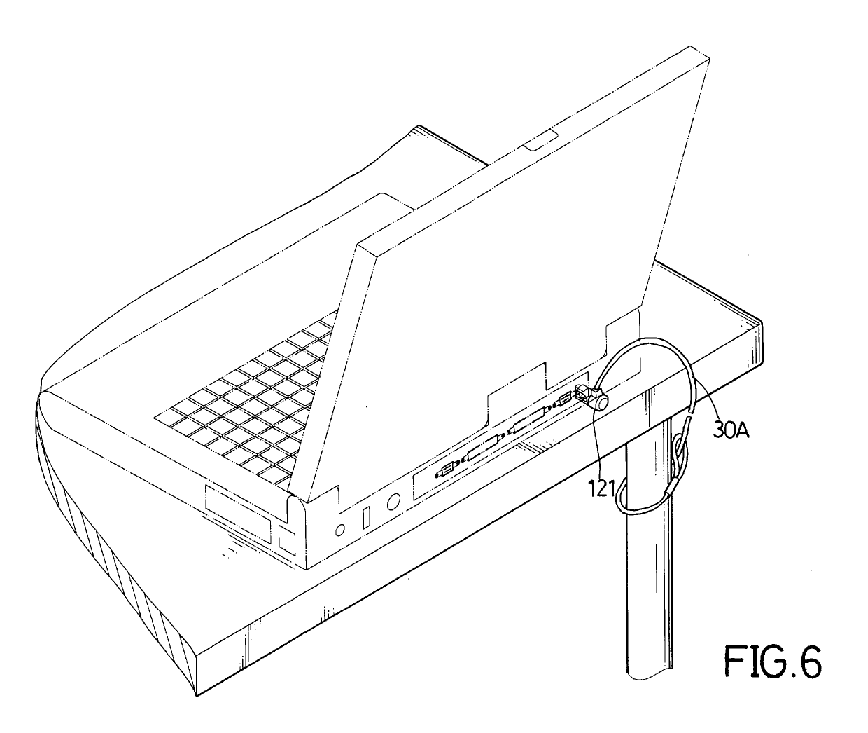

With reference to FIG. 6, it is noted that after the movement of the bolt (13A) is limited by the cable (30A), the other distal end of the cable (30A) is able to be mounted around a table leg to secure the safety of the laptop computer.

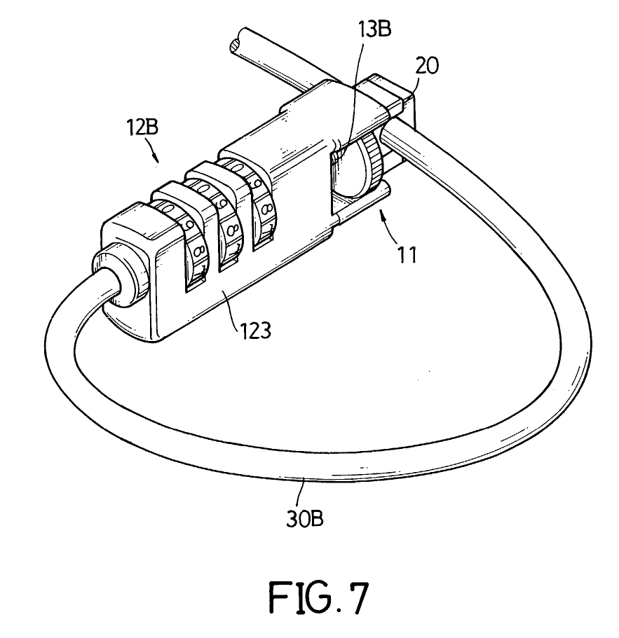

With reference to FIG. 7, the limiting portion (12B) may be a combination lock and has a series of numeral keys (123) rotatably formed on the limiting portion (12B) such that a distal end of a cable (30B) extending out from a distal end of the limiting portion (12B) is able to be moved from a first position to a second position. When the distal end of the cable (30B) is at the first position, the limiting portion (12B) is unlocked and when the distal end of the cable (30B) is at the second position, the limiting portion (12B) is locked. When the limiting portion (12B) is locked, the distal end of the bolt (13B) is abutted by the distal end of the cable (30B) such that the movement of the bolt (30B) is limited and thereby unauthorized personnel can not unscrew engagement between the secondary object (20) and the receiving portion (11).

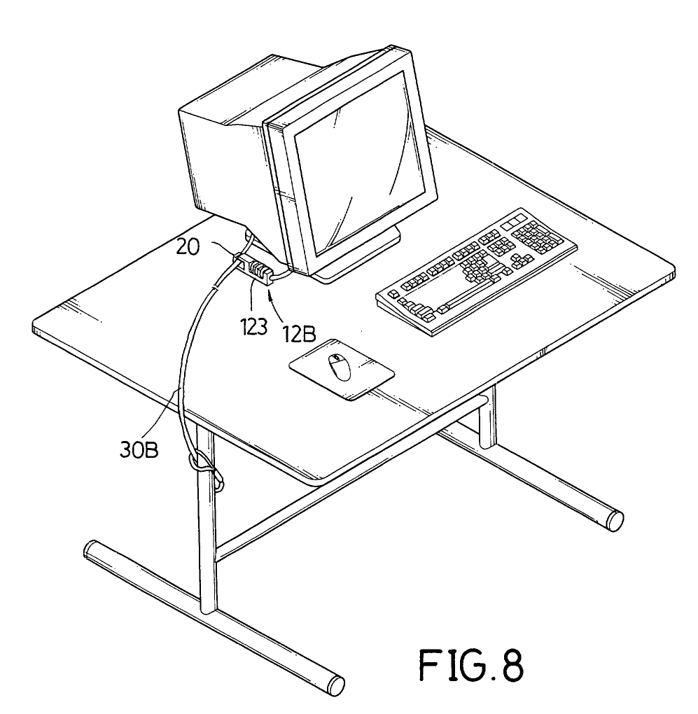

With reference to FIG. 8, it is noted that the other distal end of the cable (30B) is able to extend through the secondary object (20) to form a loop. Therefore, the operator is able to use the loop to secure an object such as a screen. Then the other distal end of the cable (30B) is formed with another loop which is able to be mounted around a table to securely connect the computer screen to the table leg.

In conclusion, there is no limitation to the internal structure of the limiting portion (12,12A,12B) and the limiting portion serves only to provide movement limitation to the bolt extending to the receiving portion to detachably connect to a secondary object (20). The safety of the object to be locked is ensured.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A locking device comprising:
a receiving portion adapted to connect to a secondary object and having a receiving space;
a limiting portion securely connected to the receiving portion and defining therein a limiting hole communicating with the receiving space via a through hole which is defined in a joint between the limiting portion and the receiving portion;
a bolt movably received in the receiving portion; and
a cable selectively extending through the limiting hole to limit movement of the bolt such that the connection of the receiving portion to the secondary object is secured.

2. The locking device as claimed in claim 1, wherein the bolt has a knob formed on a distal end of the bolt and is received in the limiting hole.

3. A locking device comprising:
a receiving portion adapted to connect to a secondary object and having a receiving space;
a limiting portion securely connected to the receiving portion and defined with a limiting hole communicating with the receiving space via a through hole which is defined in a joint between the limiting portion and the receiving portion and an actuating rod movably received in the limiting portion between a first position and a second position;
a bolt movably received in the receiving portion and a distal end of which is selectively abutted to the actuating rod; and
a cable extending out from a side of the limiting hole to be adapted to connect to an object such that the connection of the receiving portion to the secondary object is secured.

4. The locking device as claimed in claim 3, wherein the bolt has a knob formed on a distal end of the bolt to be selectively abutted to the actuating rod.

5. A locking device comprising:
a receiving portion adapted to connect to a secondary object and having a receiving space;
a limiting portion securely connected to the receiving portion and defined with multiple numeral keys rotatably received in the receiving portion to lock and unlock the limiting portion;
a bolt movably received in the receiving portion; and
a cable extending out from a side of the limiting hole and having a distal end selectively abutted to the bolt to limit movement of the bolt and movable from a first position wherein the limiting portion is unlocked to a second position where the limiting portion is locked such that the connection of the receiving portion to the secondary object is secured.

6. The locking device as claimed in claim 5, wherein the bolt has a knob formed on a distal end of the bolt to be selectively abutted to a distal end of the cable.
